(19) United States
(12) Patent Application Publication
(10) Pub. No.: US 2026/0195113 A1
(43) Pub. Date: Jul. 9, 2026

(54) DYNAMIC ADAPTIVE PAYLOAD TRANSMISSION FOR IMAGING IN HCI ENVIRONMENT

(71) Applicant: Dell Products L.P., Round Rock, TX (US)

(72) Inventors: Yu ZHANG, Shanghai (CN); Jun CHEN, Shanghai (CN); Weiyi XIE, Wuxi (CN); Hanzhang GU, Shanghai (CN)

(73) Assignee: Dell Products L.P., Round Rock, TX (US)

(21) Appl. No.: 19/028,870

(22) Filed: Jan. 17, 2025

(30) Foreign Application Priority Data
Jan. 6, 2025 (CN) 202510018578.8

(51) Int. Cl. G06F 8/61; H04L 67/06

(52) U.S. Cl. CPC G06F 8/63; H04L 67/06

(57) ABSTRACT

An information handling system may include at least one processor and a memory. The information handling system may be a node of an information handling system cluster and may be configured to: retrieve at least one first portion of an operating system (OS) installation image file via a management network; retrieve at least one second portion of the OS installation image file from another node of the information handling system cluster via a data network, wherein the data network is higher-speed than the management network; combine the at least one first portion and the at least one second portion into the OS installation image file; boot from the OS installation image file; and install the OS from the OS installation image file.

### TECHNICAL FIELD

The present disclosure relates in general to information handling systems, and more particularly to improvements in operating system imaging techniques.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Hyper-converged infrastructure (HCI) is an IT framework that combines storage, computing, and networking into a single system in an effort to reduce data center complexity and increase scalability. Hyper-converged platforms may include a hypervisor for virtualized computing, software-defined storage, and virtualized networking, and they typically run on standard, off-the-shelf servers. One type of HCI solution is the Dell EMC VxRail™ system. Some examples of HCI systems may operate in various environments (e.g., an HCI management system such as the VMware® vSphere® ESXi™ environment, or any other HCI management system). Some examples of HCI systems may operate as software-defined storage (SDS) cluster systems (e.g., an SDS cluster system such as the VMware® vSAN™ system, or any other SDS cluster system).

In the HCI context (as well as other contexts), information handling systems may execute virtual machines (VMs) or containerized workloads for various purposes. A VM or container may generally comprise any program of executable instructions, or aggregation of programs of executable instructions, configured to execute a guest operating system on a hypervisor or host operating system in order to act through or in connection with the hypervisor/host operating system to manage and/or control the allocation and usage of hardware resources such as memory, central processing unit time, disk space, and input and output devices, and provide an interface between such hardware resources and application programs hosted by the guest operating system.

In both the HCI context and the non-HCI context, deployment of an operating system (OS) to an information handling system is a common task. This is often accomplished by retrieving the installation media (e.g., an ISO file) to a management controller of the system from a network site such as an FTP server. The management controller may then mount the image file, and the host system may boot from it, copying files to its local storage resources as needed.

The installation material may include the bootable OS installation image, drivers, software, and other tools, and so its size may be substantial. The transmission from the FTP server may thus take a long time.

One reason for this slowness is that typically the transfer uses only a low-speed management network to transfer files. When multiple nodes are imaged at the same time, the process can be even slower due to the network load. Another reason for the slowness is the processing capacity of the management controller for mounting the image file as a virtual drive, with the management controller acting as a transfer station between the FTP server and the system being imaged. Thus a management controller with modest computing resources can also become a bottleneck.

It should be noted that the discussion of a technique in the Background section of this disclosure does not constitute an admission of prior-art status. No such admissions are made herein, unless clearly and unambiguously identified as such.

### SUMMARY

In accordance with the teachings of the present disclosure, the disadvantages and problems associated with operating system imaging may be reduced or eliminated.

In accordance with embodiments of the present disclosure, an information handling system may include at least one processor and a memory. The information handling system may be a node of an information handling system cluster and may be configured to: retrieve at least one first portion of an operating system (OS) installation image file via a management network; retrieve at least one second portion of the OS installation image file from another node of the information handling system cluster via a data network, wherein the data network is higher-speed than the management network; combine the at least one first portion and the at least one second portion into the OS installation image file; boot from the OS installation image file; and install the OS from the OS installation image file.

In accordance with these and other embodiments of the present disclosure, a method may include an information handling system that is a node of an information handling system cluster retrieving at least one first portion of an operating system (OS) installation image file via a management network; the information handling system retrieving at least one second portion of the OS installation image file from another node of the information handling system cluster via a data network, wherein the data network is higher-speed than the management network; the information handling system combining the at least one first portion and the at least one second portion into the OS installation image file; the information handling system booting from the OS installation image file; and the information handling system installing the OS from the OS installation image file.

In accordance with these and other embodiments of the present disclosure, an article of manufacture may include a non-transitory, computer-readable medium having computer-executable instructions thereon that are executable by a processor of an information handling system that is a node of an information handling system cluster for: retrieving at least one first portion of an operating system (OS) installation image file via a management network; retrieving at least one second portion of the OS installation image file from another node of the information handling system cluster via a data network, wherein the data network is higher-speed than the management network; combining the at least one first portion and the at least one second portion into the OS installation image file; booting from the OS installation image file; and installing the OS from the OS installation image file.

Technical advantages of the present disclosure may be readily apparent to one skilled in the art from the figures, description and claims included herein. The objects and advantages of the embodiments will be realized and achieved at least by the elements, features, and combinations particularly pointed out in the claims.

It is to be understood that both the foregoing general description and the following detailed description are examples and explanatory and are not restrictive of the claims set forth in this disclosure.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a block diagram of an example information handling system, in accordance with embodiments of the present disclosure; and

FIG. 2 illustrates an example architecture, in accordance with embodiments of the present disclosure.

### DETAILED DESCRIPTION

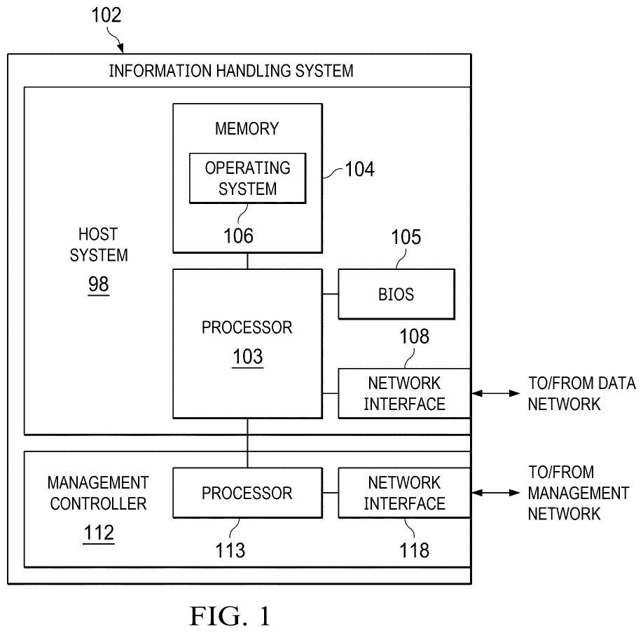

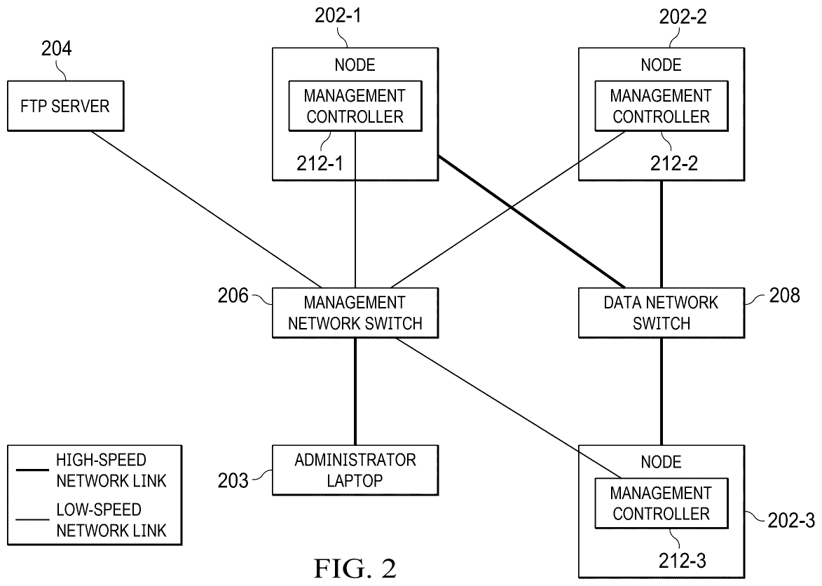

Preferred embodiments and their advantages are best understood by reference to FIGS. 1 and 2, wherein like numbers are used to indicate like and corresponding parts.

For the purposes of this disclosure, the term “information handling system” may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a personal digital assistant (PDA), a consumer electronic device, a network storage device, or any other suitable device and may vary in size, shape, performance, functionality, and price. The information handling system may include memory, one or more processing resources such as a central processing unit (“CPU”) or hardware or software control logic. Additional components of the information handling system may include one or more storage devices, one or more communications ports for communicating with external devices as well as various input/output (“I/O”) devices, such as a keyboard, a mouse, and a video display. The information handling system may also include one or more buses operable to transmit communication between the various hardware components.

For purposes of this disclosure, when two or more elements are referred to as “coupled” to one another, such term indicates that such two or more elements are in electronic communication or mechanical communication, as applicable, whether connected directly or indirectly, with or without intervening elements.

When two or more elements are referred to as “coupleable” to one another, such term indicates that they are capable of being coupled together.

For the purposes of this disclosure, the term “computer-readable medium” (e.g., transitory or non-transitory computer-readable medium) may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory; communications media such as wires, optical fibers, microwaves, radio waves, and other electromagnetic and/or optical carriers; and/or any combination of the foregoing.

For the purposes of this disclosure, the term “information handling resource” may broadly refer to any component system, device, or apparatus of an information handling system, including without limitation processors, service processors, basic input/output systems, buses, memories, I/O devices and/or interfaces, storage resources, network interfaces, motherboards, and/or any other components and/or elements of an information handling system.

For the purposes of this disclosure, the term “management controller” may broadly refer to an information handling system that provides management functionality (typically out-of-band management functionality) to one or more other information handling systems. In some embodiments, a management controller may be (or may be an integral part of) a service processor, a baseboard management controller (BMC), a chassis management controller (CMC), or a remote access controller (e.g., a Dell Remote Access Controller (DRAC) or Integrated Dell Remote Access Controller (iDRAC)).

FIG. 1 illustrates a block diagram of an example information handling system 102, in accordance with embodiments of the present disclosure. In some embodiments, information handling system 102 may comprise a server chassis configured to house a plurality of servers or “blades.” In other embodiments, information handling system 102 may comprise a personal computer (e.g., a desktop computer, laptop computer, mobile computer, and/or notebook computer). In yet other embodiments, information handling system 102 may comprise a storage enclosure configured to house a plurality of physical disk drives and/or other computer-readable media for storing data (which may generally be referred to as “physical storage resources”). As shown in FIG. 1, information handling system 102 may comprise a processor 103, a memory 104 communicatively coupled to processor 103, a BIOS 105 (e.g., a UEFI BIOS) communicatively coupled to processor 103, a network interface 108 communicatively coupled to processor 103, and a management controller 112 communicatively coupled to processor 103.

In operation, processor 103, memory 104, BIOS 105, and network interface 108 may comprise at least a portion of a host system 98 of information handling system 102. In addition to the elements explicitly shown and described, information handling system 102 may include one or more other information handling resources.

Processor 103 may include any system, device, or apparatus configured to interpret and/or execute program instructions and/or process data, and may include, without limitation, a microprocessor, microcontroller, digital signal processor (DSP), application specific integrated circuit (ASIC), or any other digital or analog circuitry configured to interpret and/or execute program instructions and/or process data. In some embodiments, processor 103 may interpret and/or execute program instructions and/or process data stored in memory 104 and/or another component of information handling system 102.

Memory 104 may be communicatively coupled to processor 103 and may include any system, device, or apparatus configured to retain program instructions and/or data for a period of time (e.g., computer-readable media). Memory 104 may include RAM, EEPROM, a PCMCIA card, flash memory, magnetic storage, opto-magnetic storage, or any suitable selection and/or array of volatile or non-volatile memory that retains data after power to information handling system 102 is turned off.

As shown in FIG. 1, memory 104 may have stored thereon an operating system 106. Operating system 106 may comprise any program of executable instructions (or aggregation of programs of executable instructions) configured to manage and/or control the allocation and usage of hardware resources such as memory, processor time, disk space, and input and output devices, and provide an interface between such hardware resources and application programs hosted by operating system 106. In addition, operating system 106 may include all or a portion of a network stack for network communication via a network interface (e.g., network interface 108 for communication over a data network). Although operating system 106 is shown in FIG. 1 as stored in memory 104, in some embodiments operating system 106 may be stored in storage media accessible to processor 103, and active portions of operating system 106 may be transferred from such storage media to memory 104 for execution by processor 103.

Network interface 108 may comprise one or more suitable systems, apparatuses, or devices operable to serve as an interface between information handling system 102 and one or more other information handling systems via an in-band network. Network interface 108 may enable information handling system 102 to communicate using any suitable transmission protocol and/or standard. In these and other embodiments, network interface 108 may comprise a network interface card, or “NIC.” In these and other embodiments, network interface 108 may be enabled as a local area network (LAN)-on-motherboard (LOM) card.

Management controller 112 may be configured to provide management functionality for the management of information handling system 102. Such management may be made by management controller 112 even if information handling system 102 and/or host system 98 are powered off or powered to a standby state. Management controller 112 may include a processor 113, memory, and a network interface 118 separate from and physically isolated from network interface 108.

As shown in FIG. 1, processor 113 of management controller 112 may be communicatively coupled to processor 103. Such coupling may be via a Universal Serial Bus (USB), System Management Bus (SMBus), and/or one or more other communications channels.

Network interface 118 may be coupled to a management network, which may be separate from and physically isolated from the data network as shown. Network interface 118 of management controller 112 may comprise any suitable system, apparatus, or device operable to serve as an interface between management controller 112 and one or more other information handling systems via an out-of-band management network. Network interface 118 may enable management controller 112 to communicate using any suitable transmission protocol and/or standard. In these and other embodiments, network interface 118 may comprise a network interface card, or “NIC.” Network interface 118 may be the same type of device as network interface 108, or in other embodiments it may be a device of a different type.

As discussed above, information handling system 102 may be a node of an HCI system that needs to be imaged with a new operating system. Embodiments of this disclosure may increase the speed with which this imaging can be accomplished.

Currently, OS imaging for host system 98 is generally accomplished by first downloading the image file via network interface 118, which connects management controller 112 to a low-speed (e.g., 1 Gbps) management network. Embodiments may improve the speed of OS imaging by leveraging the high-speed (e.g., 10 or 25 Gbps) data network that connects to network interface 108.

To aid in this process, during the process for building the installation image, the image may be split into multiple smaller files instead of one large file. For example, the data may be split into one main bootable image, plus multiple additional files. In other embodiments, the image may not be split into one main bootable image plus other files, but rather into pieces that may be recombined at the host system into the final full bootable image (e.g., a TAR archive split into multiple files). In either case, the split file may include a listing with references to the other files, as well as their hash values (e.g., MD5 values).

To initiate OS deployment on a set of nodes, a user may access a deployment management tool, which may then connect to the management controller of each node that needs to be imaged (e.g., via the management network). The deployment management tool may instruct the management controller at each such node to begin the process.

In the embodiment in which the image is split into a main bootable image file and other non-bootable pieces, the management controller may retrieve the main bootable image file from the FTP site using the low-speed management network, mount the image as a virtual media drive accessible to the host system, and cause the host system to boot the image. (An embodiment in which the image file has been split into pieces that may be recombined into the full image is described below with respect to FIG. 2.)

Once the host system has booted the main bootable image, the other files may be retrieved to the host system via the high-speed data network. These other files may be retrieved directly from the same FTP server and/or in a peer-to-peer manner from other hosts. For example, if multiple hosts are being imaged concurrently (or have been recently imaged), then they may share a given file among themselves once at least one copy of that file has been retrieved by one of the hosts.

For example, the nodes may communicate with one another (e.g., over either the management network or the data network) and negotiate how to receive each file. Each host may download some designated subset of one or more of the files from the FTP server over the low-speed management network. Once all those files are received by the various hosts, they may share them with one another over the high-speed data network until every host has a copy of every file. The installation of the OS onto the host systems may then proceed.

Embodiments may significantly decrease the amount of data that needs to be downloaded via the low-speed management network. For example, if N nodes need to be imaged with an image of size M gigabytes, then naively this would require N*M gigabytes to be transferred via the low-speed management network to the group of hosts. But by using the peer-to-peer embodiments of this disclosure, the total amount downloaded via the low-speed management network may be only M gigabytes (e.g., one full copy of the image, split up among the nodes), and the remaining (N−1)*M gigabytes may be shared among the nodes via the high-speed data network. Thus the larger the number of hosts that can be imaged concurrently, the larger the amount of time savings.

FIG. 2 shows an example architecture including three nodes 202-1, 202-2, and 202-3 with their included management controllers 212-1, 212-2, and 212-3. FTP server 204 is the source for the image files, and an administrator laptop 203 is used to send the instructions to perform the imaging.

As shown, management controllers 212 are connected to management network switch 206, as are the FTP server 204 and administrator laptop 203. The host systems of nodes 202 are connected to data network switch 208.

Suppose that the OS installation image has been built as a 30 GB file called payload.tar, which has been split into 30 pieces (s_00 through s_29). This may be accomplished via a command such as:
split -b 1G -d payload.tar s_

A listing file called payload.lst may also be generated to include a reference to each piece, along with their MD5 sums.

To image the host systems with the new OS contained in payload.tar, each node 202 needs to save a copy of each of the component parts of that file to its local storage and then reassemble those pieces into the original payload.tar.

An administrator may access an OS deployment tool from administrator laptop 203 and instruct management controllers 212 to begin the process. Nodes 202 may then begin downloading pieces of the file (e.g., selected randomly or according to a scheme that ensures each file is downloaded to only one node). While the nodes are downloading the pieces, they may broadcast a catalog to the other nodes (e.g., via the management network or the data network) containing information about their progress. For example, each node may communicate its name, IP address, and the download status of each piece that it is retrieving or has already retrieved.

When a node is ready to download the next piece of the payload, it may random select a piece that no other node is currently downloading, or that no other node has already downloaded. It may begin downloading that piece to its local storage and update the broadcast catalog to inform the other nodes, so that they will not also download that piece. When the download is complete, the node may update the catalog again to inform the other nodes that it possesses that piece, and that they can request it from the node if needed.

Concurrently, the node may also request other pieces of the payload from the other nodes via the high-speed data network once those other nodes begin advertising their possession of those pieces via their own broadcast catalogs. Thus, this embodiment avoids the duplicate downloading of pieces directly from the FTP server over the low-speed management network, taking full advantage of the high-speed network for as much of the transmission as possible.

Once a given node has received all pieces of the payload (from the FTP server, from the other nodes, or from any combination thereof), it may reassemble them into the original payload.tar file and commence installation of the new OS onto the host system.

This disclosure encompasses all changes, substitutions, variations, alterations, and modifications to the exemplary embodiments herein that a person having ordinary skill in the art would comprehend. Similarly, where appropriate, the appended claims encompass all changes, substitutions, variations, alterations, and modifications to the exemplary embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

Further, reciting in the appended claims that a structure is “configured to” or “operable to” perform one or more tasks is expressly intended not to invoke 35 U.S.C. § 112(f) for that claim element. Accordingly, none of the claims in this application as filed are intended to be interpreted as having means-plus-function elements. Should Applicant wish to invoke § 112(f) during prosecution, Applicant will recite claim elements using the “means for [performing a function]” construct.

All examples and conditional language recited herein are intended for pedagogical objects to aid the reader in understanding the invention and the concepts contributed by the inventor to furthering the art, and are construed as being without limitation to such specifically recited examples and conditions. Although embodiments of the present inventions have been described in detail, it should be understood that various changes, substitutions, and alterations could be made hereto without departing from the spirit and scope of the disclosure.

What is claimed is:

1. An information handling system comprising:
at least one processor; and
a memory;
wherein the information handling system is a node of an information handling system cluster and is configured to:
retrieve at least one first portion of an operating system (OS) installation image file via a management network;
retrieve at least one second portion of the OS installation image file from another node of the information handling system cluster via a data network, wherein the data network is higher-speed than the management network;
combine the at least one first portion and the at least one second portion into the OS installation image file;
boot from the OS installation image file; and
install the OS from the OS installation image file.

2. The information handling system of claim 1, wherein the information handling system cluster is a hyper-converged infrastructure (HCI) system.

3. The information handling system of claim 1, wherein the at least one first portion is retrieved from a file transfer protocol (FTP) server coupled to the management network.

4. The information handling system of claim 3, wherein the FTP server is not connected to the data network.

5. The information handling system of claim 1, wherein the at least one first portion is retrieved by a management controller of the information handling system.

6. The information handling system of claim 5, wherein the management controller is a baseboard management controller (BMC).

7. A method comprising:
an information handling system that is a node of an information handling system cluster retrieving at least one first portion of an operating system (OS) installation image file via a management network;
the information handling system retrieving at least one second portion of the OS installation image file from another node of the information handling system cluster via a data network, wherein the data network is higher-speed than the management network;
the information handling system combining the at least one first portion and the at least one second portion into the OS installation image file;
the information handling system booting from the OS installation image file; and
the information handling system installing the OS from the OS installation image file.

8. The method of claim 7, wherein the information handling system cluster is a hyper-converged infrastructure (HCI) system.

9. The method of claim 7, wherein the at least one first portion is retrieved from a file transfer protocol (FTP) server coupled to the management network.

10. The method of claim 9, wherein the FTP server is not connected to the data network.

11. The method of claim 7, wherein the at least one first portion is retrieved by a management controller of the information handling system.

12. The method of claim 11, wherein the management controller is a baseboard management controller (BMC).

13. An article of manufacture comprising a non-transitory, computer-readable medium having computer-executable instructions thereon that are executable by a processor of an information handling system that is a node of an information handling system cluster for:
retrieving at least one first portion of an operating system (OS) installation image file via a management network;
retrieving at least one second portion of the OS installation image file from another node of the information handling system cluster via a data network, wherein the data network is higher-speed than the management network;
combining the at least one first portion and the at least one second portion into the OS installation image file;
booting from the OS installation image file; and
installing the OS from the OS installation image file.

14. The article of manufacture of claim 13, wherein the information handling system cluster is a hyper-converged infrastructure (HCI) system.

15. The article of manufacture of claim 13, wherein the at least one first portion is retrieved from a file transfer protocol (FTP) server coupled to the management network.

16. The article of manufacture of claim 15, wherein the FTP server is not connected to the data network.

17. The article of manufacture of claim 13, wherein the at least one first portion is retrieved by a management controller of the information handling system.

18. The article of manufacture of claim 17, wherein the management controller is a baseboard management controller (BMC).
